(19) United States
(12) Patent Application Publication
(10) Pub. No.: US 2020/0218884 A1
(43) Pub. Date: Jul. 9, 2020

(54) IDENTITY RECOGNITION SYSTEM AND IDENTITY RECOGNITION METHOD

(71) Applicant: NATIONAL CHIAO TUNG UNIVERSITY, Hsinchu City (TW)

(72) Inventors: Bing-Fei WU, Hsinchu City (TW); Po-Wei HUANG, Yunlin County (TW); Wen-Chung CHEN, Taoyuan City (TW); Kuan-Hung CHEN, Hsinchu City (TW)

(21) Appl. No.: 16/379,812

(22) Filed: Apr. 10, 2019

(30) Foreign Application Priority Data
Jan. 7, 2019 (TW) 108100583

(51) Int. Cl. G06K 9/00; G06K 9/62

(52) U.S. Cl. CPC G06K 9/00288; G06F 17/141; G06K 9/6262; G06K 9/00255

(57) ABSTRACT

An identity recognition system includes a target region acquisition module, a photoplethysmography signal conversion module, a biometric characteristic conversion module, a face characteristic acquisition module, and a comparison module. The target region acquisition module is configured to acquire a plurality of target region images from a plurality of face images. The photoplethysmography signal conversion module is configured to generate a photoplethysmography signal according to the target region images. The biometric characteristic conversion module is configured to convert the photoplethysmography signal into a biometric characteristic. The face characteristic acquisition module is configured to acquire a face characteristic from the face images. The comparison module is configured to fuse the face characteristic and the biometric characteristic into a fused characteristic and perform similarity calculation on the fused characteristic and a plurality of fused characteristics stored in a database to determine identity of an identified person.

### CROSS-REFERENCE TO RELATED APPLICATION

This application claims priority to Taiwan Application Serial Number 108100583, filed Jan. 7, 2019, which is herein incorporated by reference.

### BACKGROUND

### Field of Invention

The present disclosure relates to an identity recognition system and to an identity recognition method.

### Description of Related Art

Face recognition is an identification technique for identity recognition by analyzing shapes and positional relationships of face organs. At this stage, a face image of an identified person may be captured by an image sensor, and a face characteristic may be acquired from the face image. Next, the face characteristic is compared with face characteristics of face images of known identities in a database, thereby determining the identity of the identified person based on the comparison result.

However, the conventional face recognition cannot distinguish between a living body and a photo. Taking the face recognition control system as an example, if someone uses a photo the same as a face image in a database for face recognition, it is possible to pass the face recognition control system.

It can be seen from the above that the above existing methods obviously have inconveniences and defects and need to be improved. In order to solve the above problems, efforts have been made for solutions in related fields. However, no suitable solution has been developed for a long time.

### SUMMARY

An aspect of the present disclosure provides an identity recognition system, which includes a target region acquisition module, a photoplethysmography signal conversion module, a biometric characteristic conversion module, a face characteristic acquisition module, and a comparison module. The target region acquisition module is configured to acquire a plurality of target region images from a plurality of face images of an identified person at different times. The photoplethysmography signal conversion module is configured to generate a photoplethysmography signal according to the target region images. The biometric characteristic conversion module is configured to convert the photoplethysmography signal into a biometric characteristic. The face characteristic acquisition module is configured to acquire a face characteristic from the face images. The comparison module is configured to fuse the face characteristic and the biometric characteristic into a fused characteristic and perform similarity calculation on the fused characteristic and a plurality of fused characteristics prestored in a database to determine identity of the identified person.

According to some embodiments of the present disclosure, the biometric characteristic conversion module includes an analysis conversion sub-module and a dimensionality reduction sub-module. The analysis conversion sub-module is configured to convert the photoplethysmography signal into a plurality of characteristic data according to a time-frequency analysis method, a detrended fluctuation analysis method, or a combination thereof. The dimensionality reduction sub-module is configured to reduce dimensionality of the plurality of characteristic data to generate the biometric characteristic.

According to some embodiments of the present disclosure, the time-frequency analysis method includes short-time Fourier transform, continuous wavelet transform, or discrete wavelet transform.

According to some embodiments of the present disclosure, the dimensionality reduction sub-module is configured to reduce dimensionality through a recursive neural network or a recursive convolutional neural network.

According to some embodiments of the present disclosure, the face characteristic acquisition module includes a preprocessing sub-module and a characteristic acquisition sub-module. The preprocessing sub-module is configured to perform a preprocess on the face images to generate a preprocessed face image. The characteristic acquisition sub-module is configured to acquire the face characteristic from the preprocessed face image.

According to some embodiments of the present disclosure, the characteristic acquisition sub-module is configured to acquire the face characteristic through a convolutional neural network.

According to some embodiments of the present disclosure, the comparison module includes a characteristic fuse sub-module and a calculation sub-module. The characteristic fuse sub-module is configured to perform a characteristic fuse process to fuse the face characteristic and the biometric characteristic into the fused characteristic. The calculation sub-module is configured to perform the similarity calculation on the fused characteristic and the fused characteristics in the database.

According to some embodiments of the present disclosure, the identity recognition system further includes a physiological signal calculation module. The physiological signal calculation module is configured to calculate a physiological signal of the identified person according to the photoplethysmography signal.

Another aspect of the present disclosure provides an identity recognition method, which includes (i) providing a plurality of face images of an identified person at different times; (ii) acquiring a plurality of target region images from the face images; (iii) generating a photoplethysmography signal according to the target region images; (iv) converting the photoplethysmography signal into a biometric characteristic; (v) acquiring a face characteristic from the face images; (vi) fusing the face characteristic and the biometric characteristic into a fused characteristic; and (vii) performing similarity calculation on the fused characteristic and a plurality of fused characteristics, which respectively correspond to different identities and are prestored in a database, to determine identity of the identified person according to a similarity calculation result.

According to some embodiments of the present disclosure, the step (iv) further includes: (a) converting the photoplethysmography signal into a plurality of characteristic data according to a time-frequency analysis method, a detrended fluctuation analysis method, or a combination thereof; and (b) reducing dimensionality of the plurality of characteristic data to generate the biometric characteristic.

### BRIEF DESCRIPTION OF THE DRAWINGS

FIG. 1 is a block diagram of an identity recognition system according to one embodiment of the present disclosure;

FIG. 2 is a block diagram of a biometric characteristic conversion module according to one embodiment of the present disclosure;

FIG. 3 is a block diagram of a face characteristic acquisition module according to one embodiment of the present disclosure;

FIG. 4 is a block diagram of a comparison module according to one embodiment of the present disclosure; and

FIGS. 5A and 5B are flowcharts of an operation method of an identity recognition system according to one embodiment of the present disclosure.

### DETAILED DESCRIPTION

In order that the present disclosure is described in detail and completeness, implementation aspects and specific embodiments of the present disclosure with illustrative description are presented; but it is not the only form for implementation or use of the specific embodiments. The embodiments disclosed herein may be combined or substituted with each other in an advantageous manner, and other embodiments may be added to one embodiment without further description. In the following description, numerous specific details will be described in detail in order to enable the reader to fully understand the following embodiments. However, the embodiments of the present disclosure may be practiced without these specific details.

The embodiments of the present disclosure are described in detail below, but the present disclosure is not limited to the scope of the embodiments.

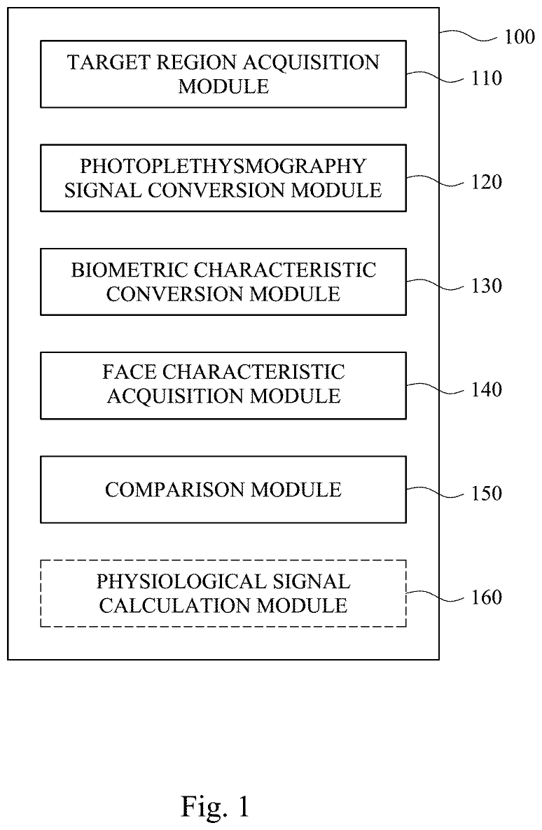

FIG. 1 is a block diagram of an identity recognition system 100 according to one embodiment of the present disclosure. The identity recognition system 100 includes a target region acquisition module 110, a photoplethysmography signal conversion module 120, a biometric characteristic conversion module 130, a face characteristic acquisition module 140, and a comparison module 150.

The target region acquisition module 110 is configured to acquire a plurality of target region images from a plurality of face images of an identified person at different times. Specifically, the target region acquisition module 110 receives the plurality of face images from an external device (not shown). For example, the external device may be an image sensor, and the face images are obtained by continuously capturing the face of the identified person by the image sensor. Therefore, there are time interval relationships between each of the face images.

The target region images are acquired from the face images. Since there are time interval relationships between each of the face images, there are also time interval relationships between each of the acquired target region images.

It should be noted that the target region acquisition module 110 may be adjusted to determine the target region to be acquired. In some embodiments, the target region to be acquired is a cheek portion, and thus the target region acquisition module 110 is adjusted such that the acquired target region images are images of the cheek portion of the identified person, but not limited thereto. When the target region to be acquired is a forehead portion or a peripheral portion around the eye, it is easy to affect the operation of the photoplethysmography signal conversion module 120 described below since these target regions are often obscured by the bangs or the worn glasses of the identified person. In addition, when the target region to be acquired is a peripheral portion around the mouth, it is easy to affect the operation of the photoplethysmography signal conversion module 120 due to mouth movement of the identified person (e.g., mouth opening and laughing).

The photoplethysmography signal conversion module 120 is configured to generate a photoplethysmography (PPG) signal according to the plurality of target region images. It should be noted that when the light passes through human skin, it is absorbed by different tissues and thus attenuated. The tissue composition of the human body should be constant, so the amount of light attenuation should be constant. However, blood in the blood vessel will have a significant volume change with the beating of the heart, and the periodic volume change will produce various amounts of attenuation. Therefore, when the light penetrates the tissue of the skin, a waveform having periodicity with ups and downs may be obtained by observing the intensity attenuation of the light. Accordingly, as described above, there are time interval relationships between each of the target region images, so that the photoplethysmography signal conversion module 120 may generate the photoplethysmography signal according to the intensity change of the light of the plurality of target region images. In some embodiments, analysis of the photoplethysmography signal conversion module 120 is performed using an independent vector analysis (IVA) method, an independent component analysis (ICA) method, or a principal component analysis (PCA) to generate the photoplethysmography signal.

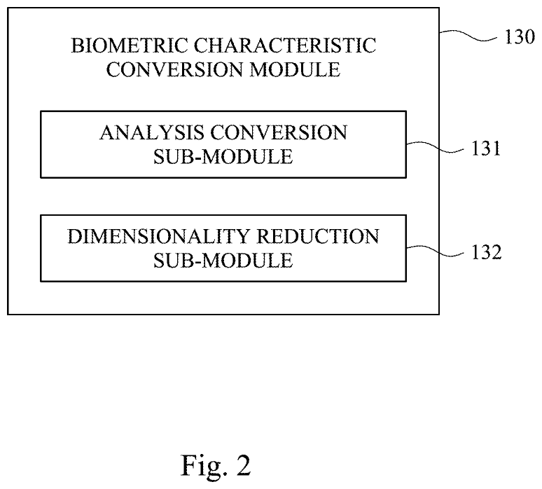

The biometric characteristic conversion module 130 is configured to convert the photoplethysmography signal into a biometric characteristic. Referring to FIG. 2 simultaneously, which is a block diagram of a biometric characteristic conversion module 130 according to one embodiment of the present disclosure. Specifically, the biometric characteristic conversion module 130 includes an analysis conversion sub-module 131 and a dimensionality reduction sub-module 132. The analysis conversion sub-module 131 is configured to convert the photoplethysmography signal into a plurality of characteristic data according to a time-frequency analysis method, a detrended fluctuation analysis (DFA) method, or a combination thereof. In some embodiments, the time-frequency analysis method includes short time Fourier transform (STFT), continuous wavelet transform (CWT), or discrete wavelet transform (DWT). The dimensionality reduction sub-module 132 is configured to reduce dimensionality of the plurality of characteristic data to generate the biometric characteristic. In some embodiments, dimensionality reduction is performed by the dimensionality reduction sub-module 132 using a recursive neural network (RNN) or a recursive convolutional neural network (RCNN).

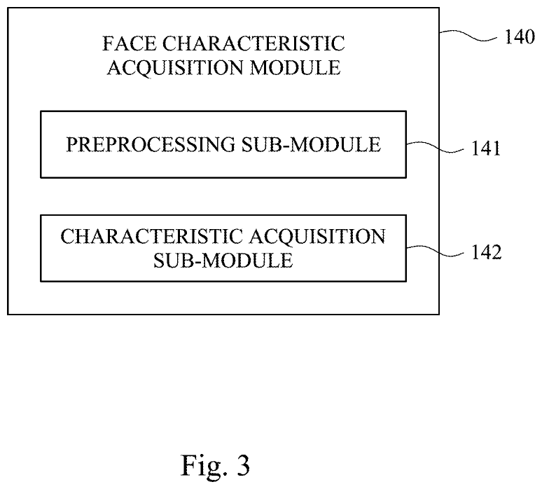

The face characteristic acquisition module 140 is configured to acquire a face characteristic from the plurality of face images. Referring to FIG. 3 simultaneously, which is a block diagram of a face characteristic acquisition module 140 according to one embodiment of the present disclosure. Specifically, the face characteristic acquisition module 140 includes a preprocessing sub-module 141 and a characteristic acquisition sub-module 142. The preprocessing sub-module 141 is configured to perform a preprocess on the plurality of face images to generate a preprocessed face image. In detail, in order to let the characteristic acquisition sub-module 142 accurately acquire the face characteristic, at least one face image is preprocessed by the preprocessing sub-module 141. The preprocess may include graying the color face image, re-adjusting the face image by cropping or zooming, performing noise reduction, fill-light or brightening on the face image, or a combination thereof. The characteristic acquisition sub-module 142 is configured to acquire the face characteristic from the preprocessed face image. In some embodiments, the characteristic acquisition sub-module 142 acquires the face characteristic through a convolutional neural network (CNN).

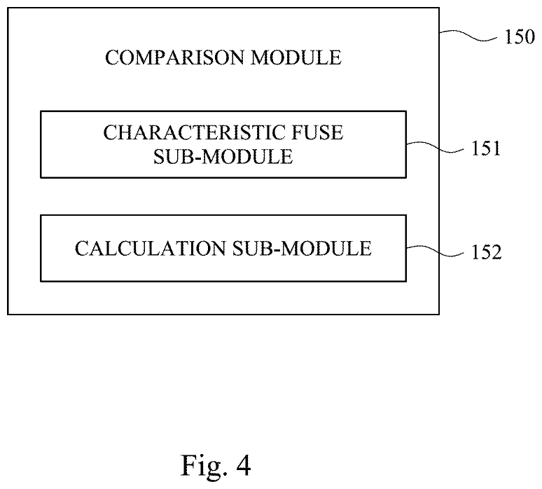

The comparison module 150 is configured to fuse the face characteristic and the biometric characteristic into a fused characteristic, and perform similarity calculation on the fused characteristic and a plurality of fused characteristics, which respectively correspond to different identities and are prestored in a database, to determine identity of the identified person according to a similarity calculation result. Referring to FIG. 4 simultaneously, which is a block diagram of a comparison module 150 according to one embodiment of the present disclosure. Specifically, the comparison module 150 includes a characteristic fuse sub-module 151 and a calculation sub-module 152. The characteristic fuse sub-module 151 is configured to perform a characteristic fuse process to fuse the face characteristic and the biometric characteristic into the fused characteristic. In detail, the face characteristic and the biometric characteristic may be represented by characteristic vectors, and the fused characteristic obtained by the characteristic fuse process may also be represented by characteristic vectors. The calculation sub-module 152 is configured to perform the similarity calculation on the fused characteristic and the plurality of fused characteristics in the database.

For example, the calculation sub-module 152 may perform the similarity calculation according to the Euclidean distance calculation method or the cosine distance calculation method. The so-called Euclidean distance calculation refers to the true distance between the two points in space, or the natural length of the vector (i.e., the distance from the point to the origin). When the Euclidean distance calculation method is used to calculate the similarity, the similarity between the two images is higher if the Euclidean distance between the two characteristic vectors respectively corresponding to the two images is smaller. Conversely, if the Euclidean distance is larger, it means that the similarity between the two images is lower. The so-called cosine distance calculation method uses the cosine value of the angle between two vectors in space as a measure of the difference between the two images. The larger the cosine value, the higher the similarity between the two images. Conversely, the smaller the cosine value, the lower the similarity between the two images.

It should be understood that the identity of the identified person may be determined according to the similarity calculation result of the calculation sub-module 152. Specifically, when the similarity between the fused characteristic and a specific fused characteristic in the database satisfies a preset condition, the identified person is determined to be the identity corresponding to the specific fused characteristic. In some embodiments, “satisfying preset condition” may be that the similarity between the fused characteristic and the specific fused characteristic in the database is greater than a preset similarity, and the value of the preset similarity may be set as needed. For example, the value of the preset similarity may be in a range of from 90% to 100%, such as 92%, 95%, 98%, or 99%.

As mentioned above, the conventional face recognition cannot distinguish between a living body and a photo. However, the identity recognition system 100 of the present disclosure combines the photoplethysmography signal conversion module 120 with the biometric characteristic conversion module 130 for generating the biometric characteristic. Since the photoplethysmography signal conversion module 120 and the biometric characteristic conversion module 130 cannot generate a biometric characteristic from a photo, the identity recognition system 100 can confirm that the identified person is a living body rather than a photo.

On the other hand, in some embodiments, the identity recognition system 100 further includes a physiological signal calculation module 160. The physiological signal calculation module 160 is configured to calculate a physiological signal of the identified person according to the photoplethysmography signal. In some embodiments, the physiological signal includes a heart rhythm variation, a heartbeat, or a combination thereof. The physiological signal of the identified person can be provided through the physiological signal calculation module 160 while determining the identity of the identified person. For example, the identity recognition system 100 of the present disclosure may be used for entry and exit personnel control of a medical care facility. As such, in addition to the identity recognition, the physiological status of a plurality of identified people can be simultaneously recorded.

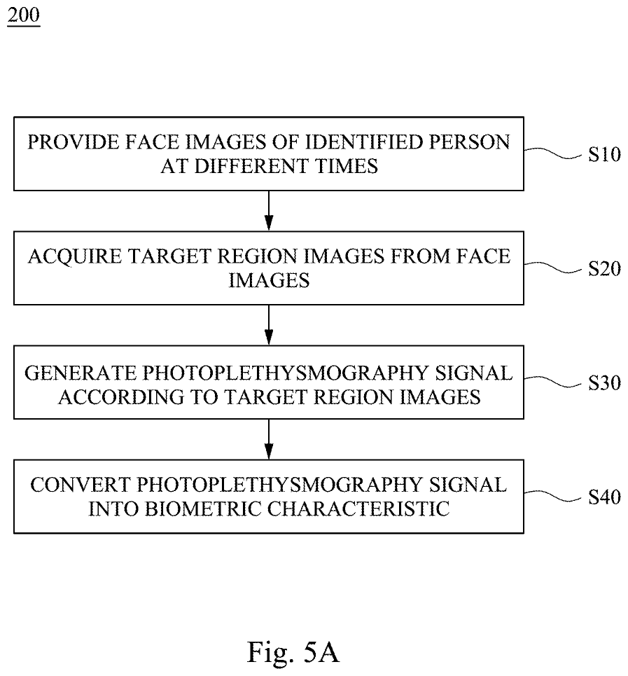

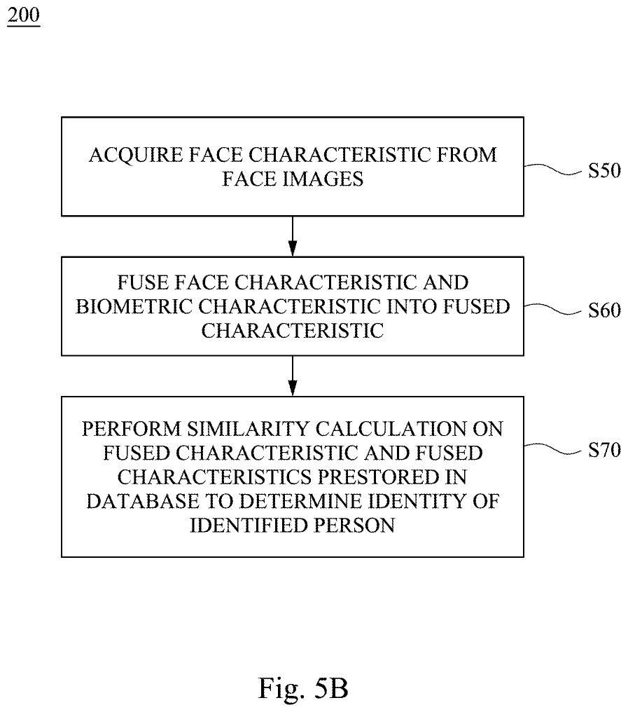

In order to describe in detail the operation mode of the identity recognition system 100, the following description will be made with reference to FIGS. 5A and 5B. FIGS. 5A and 5B are flowcharts of an operation method 200 of an identity recognition system 100 according to one embodiment of the present disclosure. It should be understood that the steps mentioned in FIGS. 5A and 5B may be adjusted according to actual needs, except for the order in which those are specifically stated. Those may also be performed simultaneously or partially simultaneously, and additional steps may be added or some steps may be omitted.

Referring to FIG. 1, FIG. 5A, and FIG. 5B simultaneously, first, in step S10, a plurality of face images of an identified person at different times are provided. For example, the plurality of face images are obtained by continuously capturing the face of the identified person by an external device (not shown) such as an image sensor.

In step S20, the target region acquisition module 110 acquires a plurality of target region images from the plurality of face images. Specifically, after receiving the plurality of face images from the external device, the target region acquisition module 110 acquires the plurality of target region images from the plurality of face images.

In step S30, the photoplethysmography signal conversion module 120 generates a photoplethysmography signal according to the plurality of target region images.

In step S40, the biometric characteristic conversion module 130 converts the photoplethysmography signal into a biometric characteristic. Specifically, as shown in FIG. 2, the analysis conversion sub-module 131 of the biometric characteristic conversion module 130 converts the photoplethysmography signal into a plurality of characteristic data according to a time-frequency analysis method, a detrended fluctuation analysis method, or a combination thereof, and the dimensionality reduction sub-module 132 of the biometric characteristic conversion module 130 reduces dimensionality of the plurality of characteristic data to generate the biometric characteristic.

In step S50, the face characteristic acquisition module 140 acquires a face characteristic from the plurality of face images. Specifically, as shown in FIG. 3, the preprocessing sub-module 141 of the face characteristic acquisition module 140 performs a preprocess on the plurality of face images to generate a preprocessed face image, and the characteristic acquisition sub-module 142 of the face characteristic acquisition module 140 acquires the face characteristic from the preprocessed face image.

In step S60, the comparison module 150 fuses the face characteristic and the biometric characteristic into a fused characteristic. Specifically, as shown in FIG. 4, the characteristic fuse sub-module 151 of the comparison module 150 performs a characteristic fuse process to fuse the face characteristic and the biometric characteristic into the fused characteristic.

In step S70, the comparison module 150 performs a similarity calculation on the fused characteristic and a plurality of fused characteristics prestored in a database to determine identity of the identified person. Specifically, the calculation sub-module 152 of the comparison module 150 performs the similarity calculation on the fused characteristic and the plurality of fused characteristics, which respectively correspond to different identities and are prestored in the database, and determines the identity of the identified person according to a similarity calculation result.

Given the above, the identity recognition system of the present disclosure combines the photoplethysmography signal conversion module with the biometric characteristic conversion module. Therefore, in addition to improving the accuracy of identity recognition, it is also possible to confirm that the identified person is a living body rather than a photo.

While the present disclosure has been disclosed above in the embodiments, other embodiments are possible. Therefore, the spirit and scope of the claims are not limited to the description contained in the embodiments herein.

It is apparent to those skilled in the art that various alternations and modifications may be made without departing from the spirit and scope of the present disclosure, and the scope of the present disclosure is defined by the scope of the appended claims.

What is claimed is:

1. An identity recognition system, comprising:
a target region acquisition module configured to acquire a plurality of target region images from a plurality of face images of an identified person at different times;
a photoplethysmography signal conversion module configured to generate a photoplethysmography signal according to the target region images;
a biometric characteristic conversion module configured to convert the photoplethysmography signal into a biometric characteristic;
a face characteristic acquisition module configured to acquire a face characteristic from the face images; and
a comparison module configured to fuse the face characteristic and the biometric characteristic into a fused characteristic and perform similarity calculation on the fused characteristic and a plurality of fused characteristics prestored in a database to determine identity of the identified person.

2. The identity recognition system of claim 1, wherein the biometric characteristic conversion module comprises:
an analysis conversion sub-module configured to convert the photoplethysmography signal into a plurality of characteristic data according to a time-frequency analysis method, a detrended fluctuation analysis method, or a combination thereof; and
a dimensionality reduction sub-module configured to reduce dimensionality of the plurality of characteristic data to generate the biometric characteristic.

3. The identity recognition system of claim 2, wherein the time-frequency analysis method comprises short-time Fourier transform, continuous wavelet transform, or discrete wavelet transform.

4. The identity recognition system of claim 2, wherein the dimensionality reduction sub-module is configured to reduce dimensionality through a recursive neural network or a recursive convolutional neural network.

5. The identity recognition system of claim 1, wherein the face characteristic acquisition module comprises:
a preprocessing sub-module configured to perform a preprocess on the face images to generate a preprocessed face image; and
a characteristic acquisition sub-module configured to acquire the face characteristic from the preprocessed face image.

6. The identity recognition system of claim 5, wherein the characteristic acquisition sub-module is configured to acquire the face characteristic through a convolutional neural network.

7. The identity recognition system of claim 1, wherein the comparison module comprises:
a characteristic fuse sub-module configured to perform a characteristic fuse process to fuse the face characteristic and the biometric characteristic into the fused characteristic; and
a calculation sub-module configured to perform the similarity calculation on the fused characteristic and the fused characteristics prestored in the database.

8. The identity recognition system of claim 1, further comprising a physiological signal calculation module configured to calculate a physiological signal of the identified person according to the photoplethysmography signal.

9. An identity recognition method, comprising:
(i) providing a plurality of face images of an identified person at different times;
(ii) acquiring a plurality of target region images from the face images;
(iii) generating a photoplethysmography signal according to the target region images;
(iv) converting the photoplethysmography signal into a biometric characteristic;
(v) acquiring a face characteristic from the face images;
(vi) fusing the face characteristic and the biometric characteristic into a fused characteristic; and
(vii) performing similarity calculation on the fused characteristic and a plurality of fused characteristics, which respectively correspond to different identities and are prestored in a database, to determine identity of the identified person according to a similarity calculation result.

10. The identity recognition method of claim 9, wherein the step (iv) further comprises:
(a) converting the photoplethysmography signal into a plurality of characteristic data according to a time-frequency analysis method, a detrended fluctuation analysis method, or a combination thereof; and
(b) reducing dimensionality of the plurality of characteristic data to generate the biometric characteristic.
